(19) United States
(12) Patent Application Publication
(10) Pub. No.: US 2019/0080338 A1
(43) Pub. Date: Mar. 14, 2019

(54) REPUTATION MANAGEMENT

(71) Applicant: INTERNATIONAL BUSINESS MACHINES CORPORATION, ARMONK, NY (US)

(72) Inventors: FREDERIC LAVIGNE, Antibes (FR); LIONEL P. MACE, Valbonne (FR); OLIVIER OUDOT, Vallauris (FR); GABRIEL A.M.H. ROUSSEAU, VALBONNE (FR)

(21) Appl. No.: 15/704,312

(22) Filed: Sep. 14, 2017

(51) Int. Cl. G06Q 30/02; G06F 7/02; G06F 17/27

(52) U.S. Cl. CPC G06Q 30/0201; G06F 17/2785; G06F 7/026

(57) ABSTRACT

Detecting malware attacks is described herein. A computer-implemented method may include receiving, via a processor, events from a plurality of activity monitors. The method also include extracting, via the processor, a plurality of behavioral features from the received events. The method may further include detecting, via the processor, a malware attack based on the extracted behavioral features using a malware identification model trained on private data and public data. The method may also include executing, via the processor, an ad hoc protection improvement based on the detected malware attack.

### BACKGROUND

The present invention relates to reputation management and more particularly to managing reputation of an individual, group or organization based on published information.

Reputation management refers to the influencing and controlling of the reputation of an individual, group or organization. The recent growth of the internet, communication networks and social media, have made publications and published information a core part of an individual's or group's reputation.

With developments in the field of public relations, combined with the growth of the internet and social media, publications on the various communication and social media networks has become an integral part of what defines a reputation. Reputation management therefore now exists under two main categories: online and off-line reputation management.

Online Reputation Management (ORM) typically focuses on the management of reputation within the digital environment, whereas, off-line reputation management normally refers to the process of managing public perception of an individual, group or organization outside the digital environment.

Reputation management is widely acknowledged as a valuable intangible asset which can be an important sources of competitive edge in a fiercely competitive market. With individuals, groups and/or organizations increasingly under scrutiny from other individuals, organizations or online communities, reputation management assists in coping with such scrutiny. Other benefits of reputation management include reinforcement of communication and/or branding objectives and the controlling of public perception(s).

### SUMMARY

According to an embodiment of the present invention there is provided a computer-implemented method for managing reputation. The method comprises obtaining a set of publications, each publication having an associated reputation score. The method further comprises selecting one or more publications from the set of publications based on their associated reputation scores. For each of the selected one or more publications, the method determines an associated measure of influence and determines whether to publish the publication based on its associated measure of influence.

According to another embodiment of the present invention, there is provided a computer program product for managing reputation. The computer program product comprises a computer readable storage medium having program instructions embodied therewith. The program instructions are executable by a processing unit to cause the processing unit to perform a method comprising: obtaining a set of publications, each publication having an associated reputation score; selecting one or more publications from the set of publications based on their associated reputation scores; and for each of the selected one or more publications: determining an associated measure of influence; and determining whether to publish the publication based on its associated measure of influence.

According to yet another aspect, there is provided a processing system comprising at least one processor and the computer program product according to one or more embodiments, wherein the at least one processor is adapted to execute the computer program code of said computer program product.

According to another aspect, there is provided a system for managing reputation. The system comprises an interface component adapted to obtain a set of publications, each publication having an associated reputation score. The system also comprises an analysis component adapted to select one or more publications from the set of publications based on their associated reputation scores. The system further comprises a publication assessment component adapted to, for each of the selected one or more publications: determine an associated measure of influence; and determine whether to publish the publication based on its associated measure of influence.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 depicts a pictorial representation of an example distributed system in which aspects of the illustrative embodiments may be implemented;

FIG. 2 is a block diagram of an example code processing system in which aspects of the illustrative embodiments may be implemented;

FIG. 3 depicts a flow diagram of an exemplary embodiment;

FIG. 4 is a simplified block diagram illustrating an exemplary embodiment;

FIG. 5 is a simplified block diagram of a networked system comprising a computer system according to an embodiment;

FIG. 6 depicts a cloud computing environment according to an embodiment of the present invention; and

FIG. 7 depicts abstraction model layers according to an embodiment of the present invention.

### DETAILED DESCRIPTION

It should be understood that the Figures are merely schematic and are not drawn to scale. It should also be understood that the same reference numerals are used throughout the Figures to indicate the same or similar parts.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

Also, in the context of the present application, a (code) system may be a single device or a collection of distributed devices that are adapted to execute one or more embodiments of the methods of the present invention. For instance, a system may be a personal computer (PC), a server or a collection of PCs and/or servers connected via a network such as a local area network, the Internet and so on to cooperatively execute at least one embodiment of the methods of the present invention.

The present invention seeks to provide a method for managing reputation by controlling publishing of publications. The proposed concept(s) may automatically manage a reputation by controlling a flow (e.g. communication or publication) of publications so as to align with an objective or target reputation. Embodiments may thus provide support for the automatic and/or dynamic control of an individual's, group's or organization's reputation via controlled/managed communication of publications or information. Proposed concepts may therefore enable improved Online Reputation Management (ORM) and/or improved off-line reputation management.

The present invention further seeks to provide a computer program product including computer program code for implementing the method when executed on a processor of a data processing system.

The present invention yet further seeks to provide a processing system adapted to execute this computer program code.

Proposed is a concept of filtering publications based on a measure of reputation associated with each of the publications. In this way, a dynamic information flow of publications may be filtered so as to select the best (or most appropriate) publications for communication to a target or intended audience in order to reach, achieve or maintain a target reputation. For instance, from a collection of available publications a subset of publications may be selected for communication which best fits an intended reputation or message to be conveyed, thus enabling an individual, group or organization to influence an associated reputation though the controlled communication of publications. Such control may be undertaken via an automated process that can dynamically select one or more publications so as to influence reputation.

For instance, a selected set of publications may be used in conjunction with a monitoring process that assesses a level of influence of publications so as to filter publications that will not have a desired impact or influence on reputation. By example only, a measure of influence of a publication may be based on factors such as: an origin or source of the publication; a measure of confidence in the publication; historical information relating to one or more previous publishing instances of the publication; a date associated with the publication; an age or date of the publication; a length or size of the publication; a language of the publication; a cross-reference made by the publication; a copyright restriction associated with the publication; a topic of the publication; a number of grammatical errors in the publication; a number of paragraphs, sentences or words of the publication; and a measure of writing style. The measure of influence may thus describe an amount or quantity by which a publication may change or modify a reputation (positively or negatively) if published, and this may further depend, for example, on factors associated with the publishing process including: date and/or time of publishing; intended purpose or target of publishing; communication platform used for publishing; intended or target audience, etc.

Proposed embodiments may therefore intelligently and/or strategically select publications from an available set or collection so as to reorient a reputation towards a predefined or desired target. This may be done dynamically, for example in response to changes in the available publications, modification to the target reputation, and/or changes in an audience.

Proposed concepts may support a transition to ORM by supporting automated management of publications whilst enabling control over the communication of such publications, for example via control of the factors/variables used to determine a reputation score and/or a measure of influence for a publication.

Embodiments may thus provide concepts that facilitate the efficient creation and adjustment of publications (such as written electronic communications) for a target audience. Such a target audience may comprise a single person or a group of people.

By way of further example, embodiments may propose extensions to publication authoring tools for indicating characteristics of publications that may be relevant for determining an associated reputation score or measure of influence. Such extensions may provide constraints on how a publication should preferably be authored or created in order to take advantage of the proposed concepts. In this way, an author or creator of a publication may be assisted in the provision of appropriate content (e.g. written material, digital content, opinions, advertisements, etc.).

Also, it is noted that, although embodiments are presented in the context of being applicable in the relation to publications in the form of electronic communications, applicability of the proposed concepts may extend to other fields where written material or communications may be used to influence a reputation and/or where communication of publications takes place. For example, embodiments may be implemented in relation to social media interactions where a social media message that adversely effects a reputation (e.g. modifies a reputation away from a target or desired value) should be prevented from being published (e.g. communicated to an audience).

Illustrative embodiments may therefore provide concepts for analyzing one or more publications intended for an audience and controlling the provision (e.g. communication or display) of such publications in accordance to a desired/objective reputation. Dynamic analysis and communication adjustment concepts may therefore be provided by proposed embodiments. Modifications and additional steps to traditional publication storage, retrieval and provision systems may also be proposed which may enhance the value and utility of the proposed concepts.

Publications may include, but are not limited to, written communications, documents, reading material, electronic and hard copy text materials, books, manuals, magazines, newspapers, word process documents, web page documents, email, and the like. By use of the subject matter disclosed herein, the provision of such publications may be adjusted so as to adhere to a specified target reputation. Accordingly, as used herein, the term “publication” may refer to any communication containing human-readable content, such as text. Examples of such include a document, a book, a manual, speech text, or any non-electronic hard copy material. A publication can be a text document produced in electronic form by typing into a keyboard of a computer using a text editor or word processor. For example, a publication may include a markup language document (e.g., a hypertext mark-up language (HTML) web page), text embedded in a markup language document, an email, and the like. Alternatively, a publication can be in a hard copy format that is received by scanning reading material with an optical character recognition device. Further, a publication may be input by speech into a speech recognition device or program. Also, reference to publishing a publication should be understood as covering the option of re-publishing a previously-published publication. Thus, determining to publish a publication may comprise determining to re-republish a publication that has already been published. Embodiments, therefore, may not only relate to original/new publications, but may also relate to old/previous publications. Accordingly, embodiments may determine to re-publish a previously-published publication so as to influence a reputation.

The term “reputation” may refer to a reputation as perceived, observed, supposed, alleged or understood by one or more individuals, groups or organizations. Reputation may, for instance, comprise an opinion (or social evaluation) of a person or community towards an individual, group or organization. Thus, a reputation may be subjective and depend on many factors, including: context; past, current or future events; audience; external influences; audience perception; audience knowledge; etc. In an online community, such as a group of people interacting via the internet, an online reputation may play an important role in determining a credibility or trustworthiness of an entity.

Accordingly, as used herein, the term “reputation score” may refer to any suitable measure of the quality and/or contribution to a reputation that is provided by a publication. The reputation score may thus be an index that represents the contribution to a reputation made by a publication. It can be a numerical value or its derivative, a grade, a level, a graphical representation, and the like. Several formulas or processes may be used for determining a reputation score. Such reputation scoring formulas or processes may utilize mathematical formulas and/or computer or manual processes. In such processes, content of a publication may be scanned and analyzed to determine a reputation score using suitable standards and measures, such as, but not limited to, those described herein.

Numerous reputation scoring formulas, processes and algorithms are known and widely available. Embodiments may employ any such known reputation scoring formulas, processes or algorithms (or any combination thereof) in order to determine a reputation score for a publication.

Exemplary reputation scoring formulas/algorithms include: a natural language analysis algorithm; a tone analysis algorithm; and a linguistic analysis algorithm. For example, a social media reputation score may be computed based on a number of interactions or messages posted on a daily basis, a number of followers, a number of replies and interactions resulting from posts/messages, etc. A reputation score, as described herein, can be calculated using any of these exemplary formulas or processes, or any combination thereof.

Illustrative embodiments may therefore provide concepts for managing reputation by controlling the distribution or communication of publications. Such control may be implemented by selecting one or more publications from a set of publications based on reputations scores associated with the publications. The selection may be made so as to modify or reorient a reputation towards a target reputation. Dynamic reputation management or optimization may therefore be provided by proposed embodiments.

Embodiments may be at least partly based on the realization that reputation scores associated with publications may be analyzed in conjunction with a reputation objective to identify publications that may be strategically used to influence reputation towards the reputation objective. The identification of publications may take account of a measure of influence of a publication, thus enabling more effective and/or efficient use of the publications when seeking to manage or modify a reputation.

Embodiments may employ a concept of associating a reputation score of a publication with the respective publication. Such reputation scores may then be employed to select publications relevant to an objective or target reputation.

Embodiments may employ a concept of determining a measure of influence of a publication. Purely by way of example, a measure of influence of a publication may relate to: whether or not a publication is kept; an author (person/entity) of the publication; a number of views a publication has received; recipient feedback; and historical data relating to previous usage of the publication. Such a measure of influence for a selected publication may then be employed when determining whether or not to publish the publication, thereby helping to ensure that communication resources are used effectively and/or efficiently for example.

Illustrative embodiments may be utilized in many different types of publication processing and/or publishing environments. Embodiments may, for example, be employed in relation to social media messaging and/or digital advertisement development, or to managing communication of content in social networks.

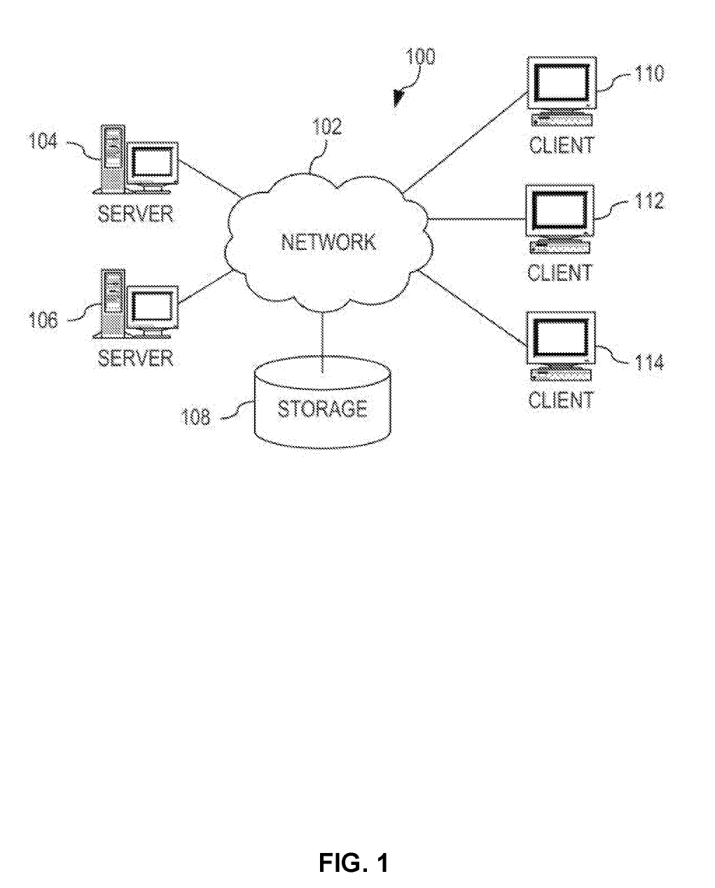

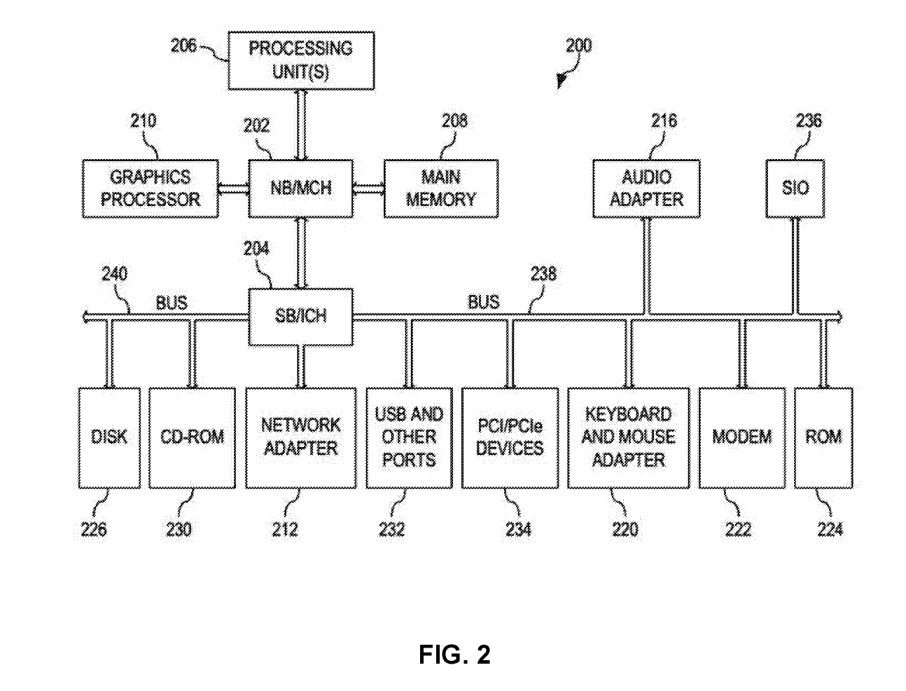

According to one aspect, a system for managing reputation may be implemented as hardware, software, and/or firmware components executing on or with one or more modules of a system operable to receive and store publications. In order to provide a context for the description of elements and functionality of the illustrative embodiments, FIGS. 1 and 2 are provided hereafter as example environments in which aspects of the illustrative embodiments may be implemented. It should be appreciated that FIGS. 1 and 2 are only examples and are not intended to assert or imply any limitation with regard to the environments in which aspects or embodiments of the present invention may be implemented. Many modifications to the depicted environments may be made without departing from the spirit and scope of the present invention.

In some embodiments, the step of obtaining a set of publications may comprise identifying a group of publications, and then, for each publication of the group of publications, a reputation score for the publication may be determined in accordance with a reputation scoring algorithm. The determined reputation score may then be associated with the publication. Thus, rather than being provided with a set of publications (or retrieving a set of publications from one or more data stores) that already have associated reputation scores, some embodiments may be adapted to identify publications and then process the identified publications so as to provide a set of publications with associated reputation scores. Such embodiments may thus be self-sufficient, in that they may not require specially formatted or processed publications but may instead be used with any publications (which the embodiment(s) may process and management in accordance with proposed concepts).

In proposed embodiments, the reputation scoring algorithm may comprise at least one of: a natural language analysis algorithm; a tone analysis algorithm; a linguistic analysis algorithm. Purely by way of example, a reputation scoring algorithm may consider a number of views/shares/comments the publication has received. It may also compute the readability of the publication (as done by widely-known algorithms that are already known and available). Sentiment analysis, tone analysis, extracting entities and keywords may also be used. Such techniques may fall under the field of natural language analysis for example Embodiments may therefore employ any suitable reputation scoring formula, process or algorithm (or any combination thereof) in order to determine a reputation score for a publication. Such algorithms may already exist and be widely-known. Embodiments may therefore be simple to implement using one or more pre-existing reputation scoring algorithms or concepts.

Determining a reputation score for the publication may comprise determining a weighting factor based on an origin or source of the publication. For example, publications from trusted sources may be weighted so as to be of greater importance, influence or relevance. In this way, trusted publications may be given more weight, and thus be determined to have a higher reputation score.

Some embodiments may further comprise, removing a publication from the group of publications if its associated reputation score is less than a threshold value. In this way, the group may be filtered to remove publications having a low reputation score (e.g. publications determined to be of low quality and/or provide a low contribution to a reputation).

In some proposed embodiments, selecting one or more publications from the set of publications may comprise the steps: comparing the reputation score associated with a first publication of the set of publications with a target reputation value; and determining whether to select the first publication based on the comparison result.

Additionally, or alternatively, selecting one or more publications from the set of publications may comprise the steps: selecting a subset of publications from the set of publications so as to minimize a function based on a difference between the reputation score associated with a publication and an objective reputation value.

Some embodiments may further comprise removing a publication from the set of publications based on at least one of: a source or origin of the publication; a measure of confidence associated with the publication; historical information relating to one or more previous publishing instances of the publication; a date associated with the publication; a topic of the publication; a number of grammatical errors in the publication; a number of paragraphs, sentences or words of the publication; recipient feedback; a measure of similarity to another publication in the set of publications; an age or publication date of the publication; and a measure of writing style.

FIG. 1 depicts a pictorial representation of an example distributed system in which aspects of the illustrative embodiments may be implemented. Distributed system 100 may include a network of computers in which aspects of the illustrative embodiments may be implemented. The distributed system 100 contains at least one network 102, which is the medium used to provide communication links between various devices and computers connected together within the distributed data processing system 100. The network 102 may include connections, such as wire, wireless communication links, or fiber optic cables.

In the depicted example, a first 104 and second 106 servers are connected to the network 102 along with a storage unit 108. In addition, clients 110, 112, and 114 are also connected to the network 102. The clients 110, 112, and 114 may be, for example, personal computers, network computers, or the like. In the depicted example, the first server 104 provides data, such as boot files, operating system images, and applications to the clients 110, 112, and 114. Clients 110, 112, and 114 are clients to the first server 104 in the depicted example. The distributed processing system 100 may include additional servers, clients, and other devices not shown.

In the depicted example, the distributed system 100 is the Internet with the network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, the distributed system 100 may also be implemented to include a number of different types of networks, such as for example, an intranet, a local area network (LAN), a wide area network (WAN), or the like. As stated above, FIG. 1 is intended as an example, not as an architectural limitation for different embodiments of the present invention, and therefore, the particular elements shown in FIG. 1 should not be considered limiting with regard to the environments in which the illustrative embodiments of the present invention may be implemented.

FIG. 2 is a block diagram of an example system 200 in which aspects of the illustrative embodiments may be implemented. The system 200 is an example of a computer, such as client 110 in FIG. 1, in which computer usable code or instructions implementing the processes for illustrative embodiments of the present invention may be located.

In the depicted example, the system 200 employs a hub architecture including a north bridge and memory controller hub (NB/MCH) 202 and a south bridge and input/output (I/O) controller hub (SB/ICH) 204. A processing unit 206, a main memory 208, and a graphics processor 210 are connected to NB/MCH 202. The graphics processor 210 may be connected to the NB/MCH 202 through an accelerated graphics port (AGP).

In the depicted example, a local area network (LAN) adapter 212 connects to SB/ICH 204. An audio adapter 216, a keyboard and a mouse adapter 220, a modem 222, a read only memory (ROM) 224, a hard disk drive (HDD) 226, a CD-ROM drive 230, a universal serial bus (USB) ports and other communication ports 232, and PCI/PCIe devices 234 connect to the SB/ICH 204 through first bus 238 and second bus 240. PCI/PCIe devices may include, for example, Ethernet adapters, add-in cards, and PC cards for notebook computers. PCI uses a card bus controller, while PCIe does not. ROM 224 may be, for example, a flash basic input/output system (BIOS).

The HDD 226 and CD-ROM drive 230 connect to the SB/ICH 204 through second bus 240. The HDD 226 and CD-ROM drive 230 may use, for example, an integrated drive electronics (IDE) or a serial advanced technology attachment (SATA) interface. Super I/O (SIO) device 236 may be connected to SB/ICH 204.

An operating system runs on the processing unit 206. The operating system coordinates and provides control of various components within the system 200 in FIG. 2. As a client, the operating system may be a commercially available operating system. An object-oriented programming system, such as the Java™ programming system, may run in conjunction with the operating system and provides calls to the operating system from Java™ programs or applications executing on system 200.

As a server, system 200 may be, for example, an IBM® System p® computer system, running the Advanced Interactive Executive (AIX®) operating system or the LINUX® operating system. The system 200 may be a symmetric multiprocessor (SMP) system including a plurality of processors in processing unit 206. Alternatively, a single processor system may be employed.

Instructions for the operating system, the programming system, and applications or programs are located on storage devices, such as HDD 226, and may be loaded into main memory 208 for execution by processing unit 206. Similarly, one or more message processing programs according to an embodiment may be adapted to be stored by the storage devices and/or the main memory 208.

The processes for illustrative embodiments of the present invention may be performed by processing unit 206 using computer usable program code, which may be located in a memory, such as main memory 208, ROM 224, or in one or more peripheral devices 226 and 230.

A bus system, such as first bus 238 or second bus 240 as shown in FIG. 2, may comprise one or more buses. Of course, the bus system may be implemented using any type of communication fabric or architecture that provides for a transfer of data between different components or devices attached to the fabric or architecture. A communication unit, such as the modem 222 or the network adapter 212 of FIG. 2, may include one or more devices used to transmit and receive data. A memory may be, for example, main memory 208, ROM 224, or a cache such as found in NB/MCH 202 in FIG. 2.

Those of ordinary skill in the art will appreciate that the hardware in FIGS. 1 and 2 may vary depending on the implementation. Other internal hardware or peripheral devices, such as flash memory, equivalent non-volatile memory, or optical disk drives and the like, may be used in addition to or in place of the hardware depicted in FIGS. 1 and 2. Also, the processes of the illustrative embodiments may be applied to a multiprocessor data processing system, other than the system mentioned previously, without departing from the spirit and scope of the present invention.

Moreover, the system 200 may take the form of any of a number of different data processing systems including client computing devices, server computing devices, a tablet computer, laptop computer, telephone or other communication device, a personal digital assistant (PDA), or the like. In some illustrative examples, the system 200 may be a portable computing device that is configured with flash memory to provide non-volatile memory for storing operating system files and/or user-generated data, for example. Thus, the system 200 may essentially be any known or later-developed data processing system without architectural limitation.

A proposed concept may enhance a reputation management system by enabling control or management of the distribution, sharing or communication of publications so as to influence or modify a reputation towards a target or objective. Embodiments may enable publications to be selected according to associated reputation values so as to provide publications that are relevant and/or useful for modifying a reputation. From the selected publications, it may be determined whether or not to publish a publication based on a measure of influence. In this way, relevant or effective publications may be published, whilst irrelevant or ineffective publications may be ignored (e.g. prevented from being published).

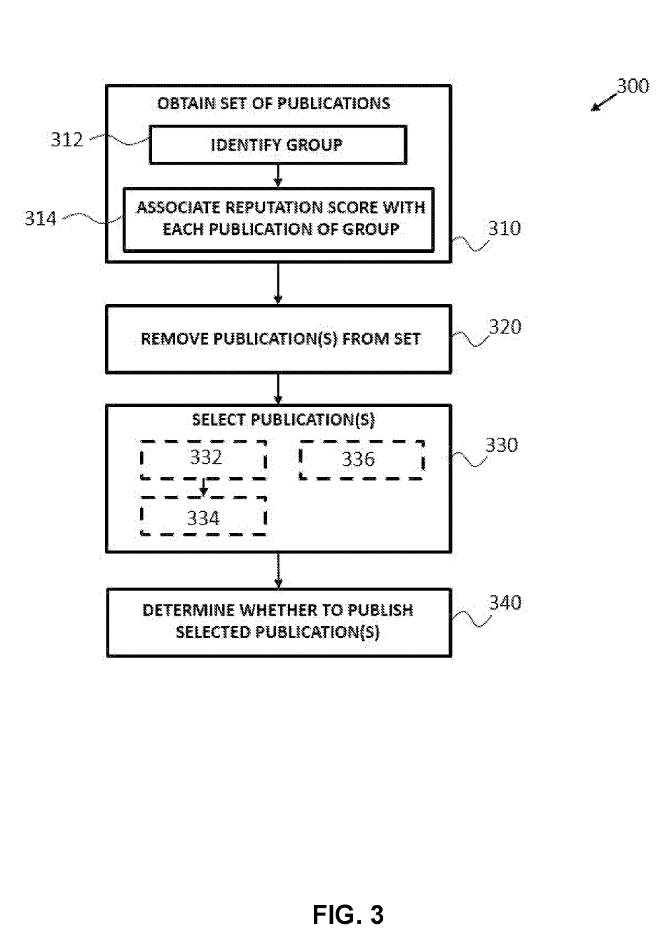

Referring now to FIG. 3, there is depicted a flow diagram of a computer-implemented method for managing reputation 300 according to an exemplary embodiment.

The method begins with the step 310 of obtaining a set of publications, each publication having an associated reputation score. Here, each publication may comprise at least one of: electronic text material; an electronic document; a web page document; an electronic message; and an email. By way of example only, the step 310 of obtaining a set of publications in this embodiment may include the step 312 of identifying a group of publications (e.g. available in one or more data repositories) and then the step 314 of, for each publication of the group of publications: determining a reputation score for the publication in accordance with a reputation scoring algorithm; and associating the determined reputation score with the publication. Here, the reputation scoring algorithm may comprise a natural language analysis algorithm. However, it will be appreciated that other embodiments may employ any suitable reputation scoring formula, process or algorithm (or any combination thereof) in order to determine a reputation score for a publication.

It is also noted that determining a reputation score for a publication may also include applying a weighting factor based on an origin or source of the publication. For example, publications from trusted sources may be weighted so as to be of greater importance, influence or relevance. In this way, trusted publications may be given more weight, and thus be determined to have a higher reputation score.

The method proceeds to the step 320 of removing a publication from the group of publications. By way of example, a publication may be removed if its associated reputation score is less than a threshold value. Alternatively, or additionally, removing a publication from the set of publications may be based on at least one of: a source or origin of the publication; a measure of influence associated with the publication; a measure of confidence in the publication; historical information relating to one or more previous publishing instances of the publication; a date associated with the publication; a topic of the publication; a number of grammatical errors in the publication; a number of paragraphs, sentences or words of the publication; and a measure of writing style. Thus, the method may be adapted to filter the obtained group so as to remove any publications having a low reputation score (e.g. publications determined to be of low quality and/or provide a low contribution to a reputation).

Next, in step 330, one or more publications are selected from the set of publications based on their associated reputation scores. In this way, the most appropriate, or best, publications may be selected from a pool of publications. By way of example, the step 330 of selecting may comprise: step 332 of comparing the reputation score associated with a first publication of the set of publications with a target reputation value; and then the step 334 of determining whether to select the first publication based on the comparison result.

Alternatively, or additionally, the step 330 of selecting may comprise: the step 336 of selecting a subset of publications from the set of publications so as to minimize a function based on a difference between the reputation score associated with a publication and an objective reputation value. For instance, step 336 may comprise selecting the minimum number of publications from the set whose average distance from an objective reputation is lower than a predetermined threshold or target value.

Finally, in step 340, for each of the selected one or more publications: an associated measure of influence is determined and, based its associated measure of influence on the determined, it is determined whether or not to publish the publication. By example only, a measure of influence of a publication may be determined based on various factors such as: an origin or source of the publication; a measure of confidence in the publication; historical information relating to one or more previous publishing instances of the publication; a date associated with the publication; a topic of the publication; a number of grammatical errors in the publication; a number of paragraphs, sentences or words of the publication; and a measure of writing style. The measure of influence may thus describe an amount or quantity by which a publication may change or modify a reputation (positively or negatively) if published, and this may further depend, for example, on factors associated with the publishing process including: date and/or time of publishing; intended purpose or target of publishing; communication platform used for publishing; intended or target audience, etc. In this way, only publications having a desired level of influence on reputation may be published to ensure that communication resources are used effectively and/or efficiently for example.

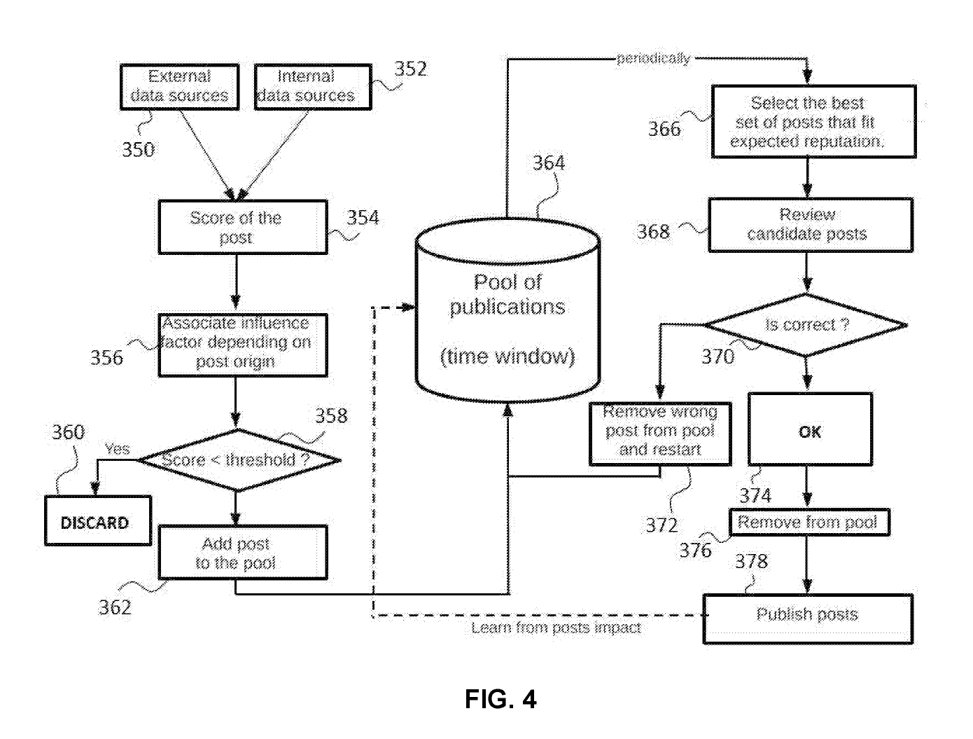

Referring now to FIG. 4, there is illustrated an exemplary embodiment by way of a diagram that summarizes aspects of the proposed concept(s).

Publications may be obtained from external data sources 350 and internal data sources 352. The obtained publications may be analysed using a reputation analyzer so as to obtain a reputation score for each publication (as depicted by the box labelled ‘354’). For instance, a reputation analyzer tool may be used to quantify a reputation score for each publication. Such a tool may determine a reputation score based on a number of well-defined criteria Cᵢ, 1≤i≤N. An analysis result may, for example, comprise a tuple of scores T(P)=(t₁, t₂, . . . , t_{N}), with tᵢ the score of Cᵢ, 0≤tᵢ≤1. Also, a function may be defined so as to measure distance between two sets of analysis results. For example: dist(A,B)=SUM{(Ai−Bi)/N} for i=1 to N with values in [−1,1].

As depicted by box 356, an influence factor (e.g. weighting value) may be applied to the reputation score for a publication, and this may be based on an origin or source of the publication.

A target (e.g. threshold) reputation score to reach may be defined and then used as a threshold/target value for determining whether or not to remove a publication from the set of obtained publications. Thus, in 358, the reputation score for a publication is compared against the determined threshold value. If it does not meet (e.g. equal or exceed) the threshold/target, the publication may be discarded (as depicted by box 360). Conversely, if the reputation score for a publication does meet (e.g. equal or exceed) the threshold/target, the publication may be selected and added 362 to a pool 364 of publications.

The pool 364 of publications may be periodically filtered so as to reject all those that are too far from an objective reputation. For example, publications may be selected 366 from the pool and then reviewed 368. An optimization solver may be used to select the best publications that match a configurable objective function for example.
Example 1: select the minimum number of publications whose average distance with objective reputation is lower than a given threshold.
Example 2: select the best M publications that minimize average distance with objective reputation.

The implementation of such example may simply employ a trivial solver 370. Also, a confidence factor (e.g. based on a source of a publication) may be used in the computation. Publications may thus be removed 372 from the pool when they do not fit a required reputation. Conversely, publications that fit a required reputation may be marked as OK 374 for purpose and retrieved 376 from the pool and published 378.

It will thus be appreciated that embodiments may be employed to manage or control a public reputation of a natural or legal person. By intelligently selecting publications available from various sources, embodiments may automatically and dynamically reorient a reputation to a predefined target.

Proposed embodiments may employ machine learning and optimization techniques to select the most appropriate publications (e.g. those that are most relevant and have the greatest influence) to reach an objective reputation.

In some embodiments, there may be provided a system comprising a processing arrangement adapted to carry out any concept previously described with reference to FIGS. 1 to 4.

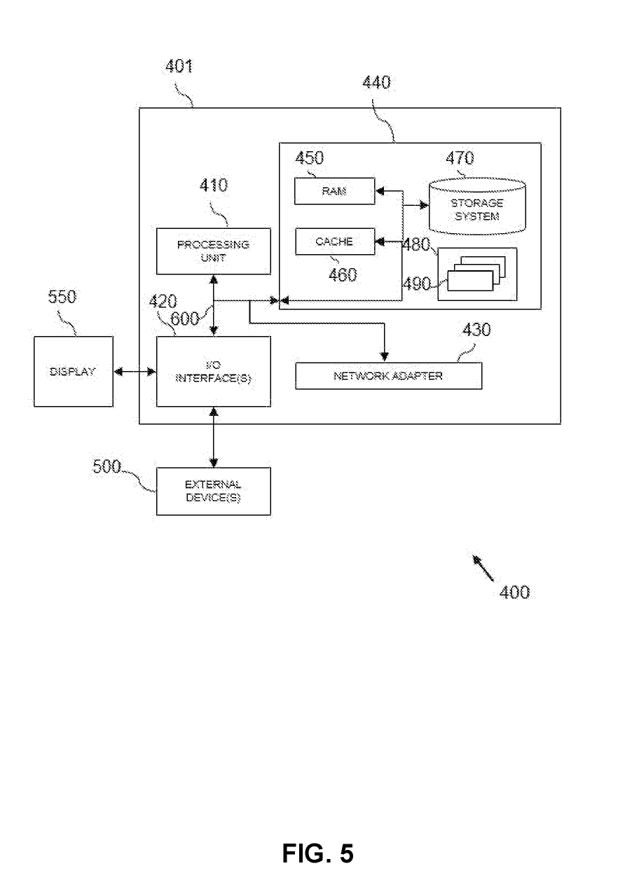

By way of example, as illustrated in FIG. 5, embodiments may comprise a computer system 401, which may form part of a networked system 400. The components of computer system/server 401 may include, but are not limited to, one or more processing arrangements, for example comprising processors or processing units 410, a system memory 440, and a bus 600 that couples various system components including system memory 440 to processing unit 410.

Bus 600 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 401 typically includes a variety of computer system readable media. Such media may be any available media that is accessible by computer system/server 401, and it includes both volatile and non-volatile media, removable and non-removable media.

System memory 440 can include computer system readable media in the form of volatile memory, such as random access memory (RAM) 450 and/or cache memory 460. Computer system/server 401 may further include other removable/non-removable, volatile/non-volatile computer system storage media. By way of example only, storage system 470 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 600 by one or more data media interfaces. As will be further depicted and described below, memory 440 may include at least one program product having a set (e.g., at least one) of program modules that are configured to carry out the functions of embodiments of the invention.

Program/utility 480, having a set (at least one) of program modules 490, may be stored in memory 440 by way of example, and not limitation, as well as an operating system, one or more application programs, other program modules, and program data. Each of the operating system, one or more application programs, other program modules, and program data or some combination thereof, may include an implementation of a networking environment. Program modules 490 generally carry out the functions and/or methodologies of embodiments of the invention as described herein.

Computer system/server 401 may also communicate with one or more external devices 500 such as a keyboard, a pointing device, a display 550, etc.; one or more devices that enable a user to interact with computer system/server 401; and/or any devices (e.g., network card, modem, etc.) that enable computer system/server 401 to communicate with one or more other computing devices. Such communication can occur via Input/Output (I/O) interfaces 420. Still yet, computer system/server 401 can communicate with one or more networks such as a local area network (LAN), a general wide area network (WAN), and/or a public network (e.g., the Internet) via network adapter 430. As depicted, network adapter 430 communicates with the other components of computer system/server 401 via bus 600. It should be understood that although not shown, other hardware and/or software components could be used in conjunction with computer system/server 401. Examples, include, but are not limited to: microcode, device drivers, redundant processing units, external disk drive arrays, RAID systems, tape drives, and data archival storage systems, etc.

In the context of the present application, where embodiments of the present invention constitute a method, it should be understood that such a method is a process for execution by a computer, i.e. is a computer-implementable method. The various steps of the method therefore reflect various parts of a computer program, e.g. various parts of one or more algorithms.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a storage class memory (SCM), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

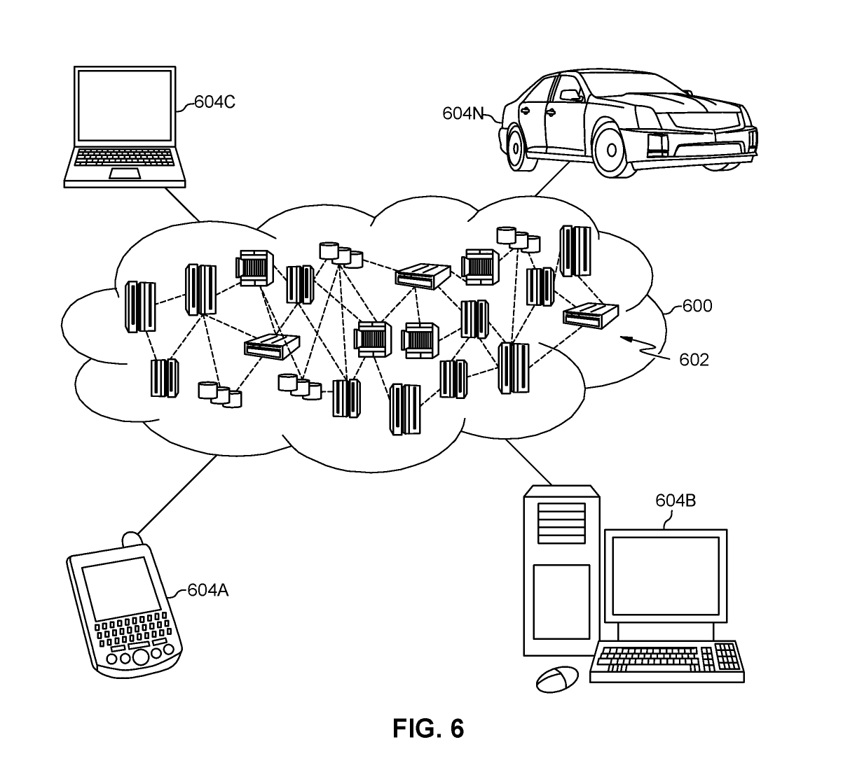

Referring now to FIG. 6, illustrative cloud computing environment 800 is depicted. As shown, cloud computing environment 800 comprises one or more cloud computing nodes 602 with which local computing devices used by cloud consumers, such as, for example, personal digital assistant (PDA) or cellular telephone 604A, desktop computer 604B, laptop computer 604C, and/or automobile computer system 604N may communicate. Nodes 602 may communicate with one another. They may be grouped (not shown) physically or virtually, in one or more networks, such as Private, Community, Public, or Hybrid clouds as described hereinabove, or a combination thereof. This allows cloud computing environment 800 to offer infrastructure, platforms and/or software as services for which a cloud consumer does not need to maintain resources on a local computing device. It is understood that the types of computing devices 604A-N shown in FIG. 6 are intended to be illustrative only and that computing nodes 602 and cloud computing environment 800 can communicate with any type of computerized device over any type of network and/or network addressable connection (e.g., using a web browser).

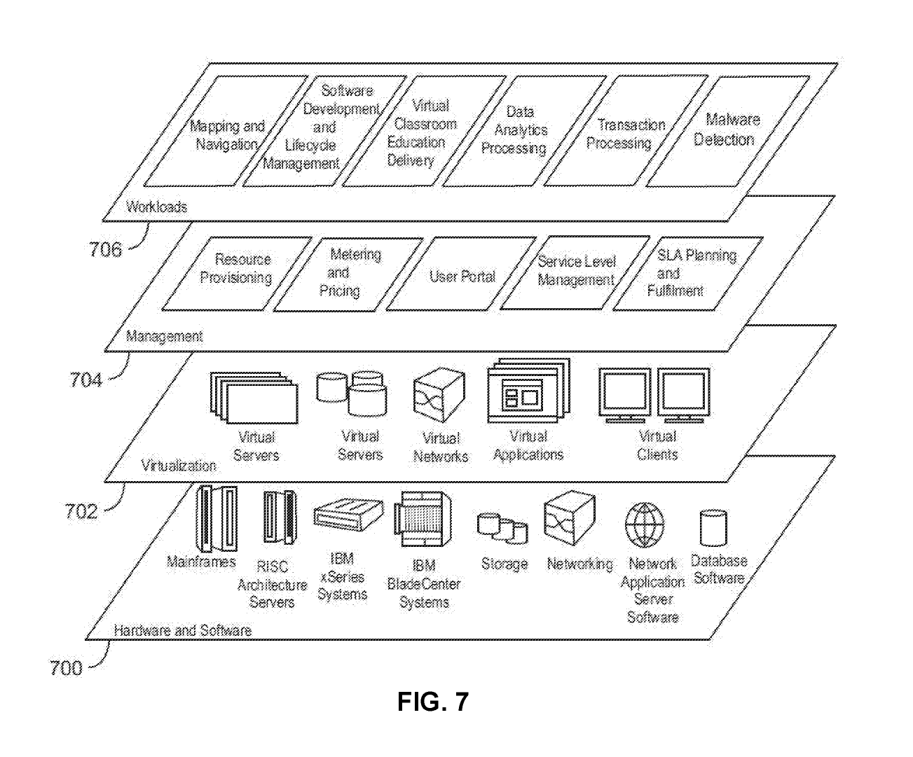

Referring now to FIG. 7, a set of functional abstraction layers provided by cloud computing environment 800 (FIG. 6) is shown. It should be understood in advance that the components, layers, and functions shown in FIG. 7 are intended to be illustrative only and embodiments of the invention are not limited thereto. As depicted, the following layers and corresponding functions are provided.

Hardware and software layer 700 includes hardware and software components. Examples of hardware components include mainframes, in one example IBM® zSeries® systems; RISC (Reduced Instruction Set Computer) architecture based servers, in one example IBM pSeries® systems; IBM xSeries® systems; IBM BladeCenter® systems; storage devices; networks and networking components. Examples of software components include network application server software, in one example IBM WebSphere® application server software; and database software, in one example IBM DB2® database software. (IBM, zSeries, pSeries, xSeries, BladeCenter, WebSphere, and DB2 are trademarks of International Business Machines Corporation registered in many jurisdictions worldwide).

Virtualization layer 702 provides an abstraction layer from which the following examples of virtual entities may be provided: virtual servers; virtual storage; virtual networks, including virtual private networks; virtual applications and operating systems; and virtual clients. In one example, management layer 704 may provide the functions described below. Resource provisioning provides dynamic procurement of computing resources and other resources that are utilized to perform tasks within the cloud computing environment. Metering and Pricing provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal provides access to the cloud computing environment for consumers and system administrators. Service level management provides cloud computing resource allocation and management such that required service levels are met. Service Level Agreement (SLA) planning and fulfillment provide pre-arrangement for, and procurement of, cloud computing resources for which a future requirement is anticipated in accordance with an SLA.

Workloads layer 706 provides examples of functionality for which the cloud computing environment may be utilized. Examples of workloads and functions which may be provided from this layer include: mapping and navigation; software development and lifecycle management; virtual classroom education delivery; data analytics processing; transaction processing; and reputation management.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for managing reputation, the method comprising:
obtaining a set of publications, wherein each publication has an associated reputation score;
selecting one or more publications from the set of obtained publications based on the associated reputation score; and
for each of the one or more selected publications:
determining an associated measure of influence; and
determining whether to publish the publication based on the associated measure of influence.

2. The method of claim 1, wherein obtaining a set of publications further comprises:
identifying a group of publications; and
for each publication within the group of identified publications:
determining a reputation score for the publication in accordance with a reputation scoring algorithm; and
associating the reputation score with the publication.

3. The method of claim 2, wherein the reputation scoring algorithm is selected from a group consisting of a natural language analysis algorithm, a tone analysis algorithm, and a linguistic analysis algorithm.

4. The method of claim 2, wherein determining a reputation score for the publication comprises determining a weighting factor based on an origin or a source of the publication.

5. The method of claim 2, further comprising:
removing a publication from the group of publications based on the associated reputation score being less than a threshold value.

6. The method of claim 1, wherein selecting one or more publications from the set of publications comprises:
comparing the reputation score associated with a first publication of the set of publications with a target reputation value; and
determining whether to select the first publication based on the comparison result.

7. The method of claim 1, wherein selecting one or more publications from the set of publications comprises:
selecting a subset of publications from the set of publications so as to minimize a function based on a difference between the reputation score associated with a publication and an objective reputation value.

8. The method of claim 1, further comprising removing a publication from the set of publications based on at least one of:
a source or origin of the publication;
a measure of influence associated with the publication;
a measure of confidence in the publication;
historical information relating to one or more previous publishing instances of the publication;
a date associated with the publication;
a length or size of the publication;
a language of the publication;
a cross-reference made by the publication;
a copyright restriction associated with the publication;
a topic of the publication;
a number of grammatical errors in the publication;
a number of paragraphs of the publication;
a number of sentences of the publication;
a number of words of the publication; and
a measure of writing style.

9. The method of claim 1, wherein a publication is selected from a group consisting of a plurality of electronic text material, an electronic document, a web page document, an electronic message, and an email.

10. A computer program product for managing reputation, the computer program product comprising a computer readable storage medium having program instructions embodied therewith, the program instructions executable by a processing unit to cause the processing unit to perform a method comprising:
obtaining a set of publications, wherein each publication has an associated reputation score;
selecting one or more publications from the set of obtained publications based on the associated reputation score; and
for each of the one or more selected publications:
determining an associated measure of influence; and
determining whether to publish the publication based on the associated measure of influence.

11. The computer program product of claim 10, wherein obtaining a set of publications further comprises:
identifying a group of publications; and
for each publication within the group of identified publications:
determining a reputation score for the publication in accordance with a reputation scoring algorithm; and
associating the reputation score with the publication.

12. A system for managing reputation, the system comprising:
an interface component adapted to obtain a set of publications, wherein each publication having an associated reputation score;
an analysis component adapted to select one or more publications from the set of publications based on their associated reputation scores; and
a publication assessment component adapted to, for each of the selected one or more publications:
determine an associated measure of influence; and
determine whether to publish the publication based on its associated measure of influence.

13. The system of claim 12, wherein the interface component comprises:
a publication identification component adapted to identify a group of publications; and
a reputation analysis component for each publication of the group of publication:
determining a reputation score for the publication in accordance with a reputation scoring algorithm; and
associating the reputation score with the publication.

14. The system of claim 13, wherein the reputation scoring algorithm is selected from a group consisting of a natural language analysis algorithm, a tone analysis algorithm, and a linguistic analysis algorithm.

15. The system of claim 13, wherein the reputation analysis component is adapted to determine a weighting factor based on an origin or a source of the publication.

16. The system of claim 13, wherein the reputation analysis component is adapted to remove a publication from the group of publications if the associated reputation score is less than a threshold value.

17. The system of claim 12, wherein the analysis component comprises:
a comparison component adapted to compare the reputation score associated with a first publication of the set of publications with a target reputation value; and
a selection component adapted to determine whether to select the first publication based on a result of the comparison.

18. The system of claim 12, wherein selecting one or more publications from the set of publications comprises:
selecting a subset of publications from the set of publications so as to minimize a function based on a difference between the reputation score associated with a publication and an objective reputation value.

19. The system of claim 12, further comprising a publication filter component adapted to remove a publication from the set of publications based on at least one of:
a source or origin of the publication;
a measure of influence associated with the publication;
historical information relating to one or more previous publishing instances of the publication;
a date associated with the publication;
a length or size of the publication;
a language of the publication;
a cross-reference made by the publication;
a copyright restriction associated with the publication;
a topic of the publication;
a number of grammatical errors in the publication;
a number of paragraphs of the publication;
a number of sentences of the publication;
a number of words of the publication; and
a measure of writing style.

20. The system of claim 12, wherein a publication is selected from a group consisting of a plurality of electronic text material, an electronic document, a web page document, an electronic message, and an email.
